(19) United States
(12) Patent Application Publication
(10) Pub. No.: US 2007/0067472 A1
(43) Pub. Date: Mar. 22, 2007

(54) Accurate and error resilient time stamping method and/or apparatus for the audio-video interleaved (AVI) format

(75) Inventors: Gregory R. Maertens, Milano (IT); Kourosh Soroushian, San Jose, CA (US)

Correspondence Address: LSI LOGIC CORPORATION, 1621 BARBER LANE, MS: D-106, MILPITAS, CA, 95035, US

(73) Assignee: LSI LOGIC CORPORATION

(21) Appl. No.: 11/230,734

(22) Filed: Sep. 20, 2005

(51) Int. Cl. G06F 15/16

(52) U.S. Cl. 709/230

(57) ABSTRACT

An apparatus comprising a first circuit and a second circuit. The first circuit may be configured to embed one or more timestamp chunks into a compressed bitstream in response to one of a video data signal and an audio data signal. The second circuit may be configured to generate an output signal in response to decoding the compressed bitstream. Each of the one or more timestamp chunks comprises an error correction mechanism configured to detect and correct errors on the compressed bitstream prior to decoding the compressed bitstream.

### FIELD OF THE INVENTION

The present invention relates to a video processing generally and, more particularly, to an accurate and error resilient time stamping method and/or apparatus for an audio-video interleaved (AVI) format.

### BACKGROUND OF THE INVENTION

The propagation of peer-to-peer networks has lead to the online sharing of video content similar to how MP3 audio files are shared and distributed. The catalyst for much of the online sharing of video content distribution has been the DivX format. The DivX format is based on the MPEG-4 video compression standard. The DivX encoding format is typically comprised of an MPEG-4 video elementary stream, along with an MP3 audio elementary stream, which is multiplexed into an Audio-Video Interleaved (AVI) file. The selection of the AVI file as the carrying format is in part due to simplicity of the AVI file, and the fact that the AVI file carrying format is available without any intellectual property restrictions. The AVI file can be ported to virtually any platform.

The AVI file format has some known flaws. In particular, the AVI format adds limitations on the tools used for content creation (e.g., not all video and audio encoding methods can be used). Also, the quality of the movie experience for the end user is not as perfect as other formats. At the same time, a growing expectation for higher audio and video quality and robustness from end users is emerging. Such quality and robustness is not completely achievable with the AVI format.

Referring to FIG. 1, a diagram illustrating a conventional AVI file format is shown. The AVI file format is constructed of a header section, followed by a multiplex of the audio and video data, and terminated with an index portion. The index portion lists the location of each audio and video frame in the multiplex. The AVI file (originally defined in the mid 1980s) is a special case of the RIFF file format. RIFF files use four-character codes to identify each of the file elements or chunks. A “chunk” is the primary building block of the AVI file format. AVI files typically comprise an RIFF form header, a list chunks (or sub-chunks), data sub-chunks and an index chunk. The RIFF Form Header is the primary file identifier. The list chunks and sub-chunks define the format of the overall stream (i.e., a header sub-chunk), as well as the individual components (i.e., a data sub-chunk). Data sub-chunks, typically carry a single video frame, and are followed by the corresponding audio frames in a different chunk. The index chunk is used for random access into the file.

In the AVI format, there is no concept of timing in the data block. In the AVI file, the only possible location for the detection of timing in the stream has to be derived from the index chunk. The index chunk pinpoints the location of each audio or video frame. However, due to the large size of the index-chunk, the derivation of the timing for the purpose of determining the correct synchronization of the audio and video data is cumbersome and needs a large amount of memory. Timing is critical for a correct synchronization of different media when presenting audio, video, or subtitles. The user experience is diminished when the synchronization is not correct.

Referring to FIG. 2, a diagram illustrating a typical audio and video multiplexing system 10 is shown. The system 10 shows a system clock 12, a video encoder 14, an audio encoder 16 and a multiplexer 26. The video encoder 14 presents a compressed video stream 18. The compressed video stream 18 shows a number of system timestamps 20a-20n. The audio encoder 16 presents a compressed audio stream 22. The compressed audio stream 22 comprises a number of system timestamps 24a-24n. The multiplexer 26 transmits either the compressed video stream 18 or the compressed audio stream 22. There are several existing implementations that maintain audio-video synchronization in a multimedia file or multiplex in addition to the system 10. The majority of these methods maintain the snapshot of a real-time clock and embed the clock within a multiplex, thus allowing the decoding system to recreate the presentation clock accurately.

In the existing AVI format, timestamps are not embedded in the video or audio streams. The timing information in the AVI format is basic and prone to error. The timing information in an AVI format can be derived from the AVI index chunk. If the stream is corrupted or missing the AVI index chunk, the entire stream (i.e., audio or video) is not playable. The timing information can also be derived from the stream. If the display duration of each chunk is known, the timestamp can be computed. For example, with a video running at 30 frames per second (fps), a first video chunk will have a timestamp of 0, then for the Nth video chunk, the Nth video chunk will have a timestamp of N/fps. The problem with obtaining the timestamp from the display duration of each chunk is that if some chunks are not decodable or are corrupted, the synchronization will be lost. The synchronization will be improper since the wrong timestamps will be used for the audio or video chunks.

Referring to FIG. 3, a diagram illustrating a typical AVI de-multiplexing system 50 is shown. Each individual media element is decoded and presented based on snapshots of the real-time clock. The system 50 shows a de-multiplexer 52, a video decoder 56, an audio decoder 60 and a television 62. A compressed video stream 54 is transmitted from the de-multiplexer 52 to the video decoder 58. With the typical AVI de-multiplexing system 50, timestamps (not shown) are used by the encoded flow to properly multiplex a compressed stream. The timestamps are not carried inside the compressed stream (i.e., the compressed video stream 54 or the compressed audio stream 56). A compressed audio stream 56 is transmitted to the audio decoder 60. The television 62 presents the audio video data to a user after a decompressed audio stream and the decompressed video stream are synchronized. The AVI file does not include any notion of an overall stream clock or a snapshot for each individual member (i.e., audio, video, etc.). The decoder 58 or 60 maintains an internal clock for each media when decoding either the compressed video stream 56 or the compressed audio stream 54 at an elementary stream level. A media clock is incremented for each unit decoded. If there are no errors, the media presentation will be free from audio-video synchronization issues.

Referring to FIG. 4, a diagram illustrating an A/V synchronization drift with a corrupted AVI stream is shown. The main assumption with such an approach is that the file/stream is error free. However, an error free stream is not always the case. For example, optical media can be scratched, or there can be errors in the stream transmission. In such scenario, the audio-video synchronization will drift, with little hope of recovery.

Media can be either encoded in a Constant Bit Rate (CBR) or a Variable Bit Rate (VBR). VBR encoding may lead to a better compression ratio and better overall quality when compared with CBR encoding. However, the use of VBR encoding creates a more complex rate control program. New encoding technologies offer the possibility of going beyond traditional VBR encoding. Not only do such technologies offer a variable bit rate, but some offer a variable rate/duration (i.e., frame rate in the case of video).

Referring to FIGS. 5-6, an example of adaptive variable frame-rate encoding and an adaptive variable frame-duration encoding example are shown. Video is typically sampled at a fixed frame rate with each “sample” (i.e., picture) having the same duration. Modern encoding technologies can take advantage of the fact that in a video scene there might be a period in which the movie is like a still picture. Such a picture can be encoded as a frame (i.e., only a single frame) for a presentation duration equal to the period of time the movie behaves like still picture.

In modern audio formats (i.e., Advanced Audio Coding (AAC), Windows Media Audio (WMA), and/or Vorbis), the number of audio samples per access unit varies from access unit to access unit. The AVI format can deal with both CBR and VBR encoding. However, for VBR encoding the AVI format needs each and every access unit to be in one AVI chunk. An additional restriction with VBR encoding is that the presentation duration of the access unit must be the same for all access units. Because the presentation duration of the access unit must be the same for all access units, the inclusion of the most advanced encoding tools in the AVI file will lead to severe audio/video synchronization problems.

While some rudimentary error detection can be performed for each individual AVI chunk. The primary mode of error detection is very limited and occurs at the elementary stream level, assuming such a mechanism is even available in the particular standard (i.e., MPEG A/V). However, the trend for new encoding tools is to have the error detection performed at the transport layer and not at the elementary stream format level (i.e., WMA). Because the AVI format does not have a significant amount of error detection, the video decoder 56 or the audio decoder 60 will present corrupted reconstructed media, ultimately damaging the user experience.

It would be desirable to provide a method and/or apparatus that may (i) provide an accurate and error resilient time stamping system for the Audio-Video Interleaved (AVI) format, (ii) augment the possibilities of the AVI format in a non-invasive fashion pertaining to audio-video synchronization, and/or (iii) make the AVI format more attractive and/or flexible to implement.

### SUMMARY OF THE INVENTION

The present invention concerns an apparatus comprising a first circuit and a second circuit. The first circuit may be configured to embed one or more timestamp chunks into a compressed bitstream in response to one of a video data signal and an audio data signal. The second circuit may be configured to generate an output signal in response to decoding the compressed bitstream. Each of the one or more timestamp chunks comprises an error correction mechanism configured to detect and correct errors on the compressed bitstream prior to decoding the compressed bitstream.

The objects, features and advantages of the present invention include providing a method and/or apparatus for an error resilient time stamping method for the audio-video interleaved (AVI) format that may (i) augment the possibilities of the AVI format, (ii) make the AVI format more attractive and flexible to a friendly device, (iii) protect all I-frames in an AVI stream by implementing an error detection/correction program, and/or (iv) allow a greater quality of service in a non-perfect transport medium.

### BRIEF DESCRIPTION OF THE DRAWINGS

These and other objects, features and advantages of the present invention will be apparent from the following detailed description and the appended claims and drawings in which:

FIG. 1 is a diagram illustrating an AVI file format presentation;

FIG. 2 is a diagram illustrating a typical audio and video multiplexer using timestamps;

FIG. 3 is a diagram illustrating AVI multiplexing and A/V presentation;

FIG. 4 is a diagram illustrating A/V synchronization drift with a corrupted AVI stream;

FIG. 5 is a diagram illustrating a adaptive variable frame rate;

FIG. 6 is a diagram illustrating an adaptive frame duration encoding and presentation;

FIG. 7 is a diagram of a decoder system in accordance with a preferred embodiment of the present invention;

FIG. 8 is a diagram of an encoder system in accordance with a preferred embodiment of the present invention; and

FIG. 9 is a diagram illustrating an example of the decoder system.

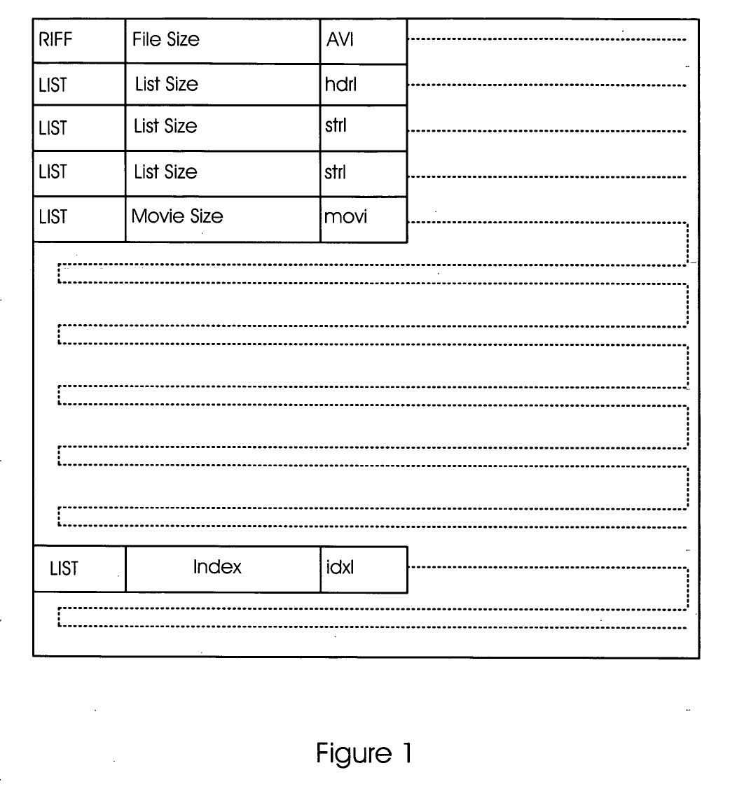

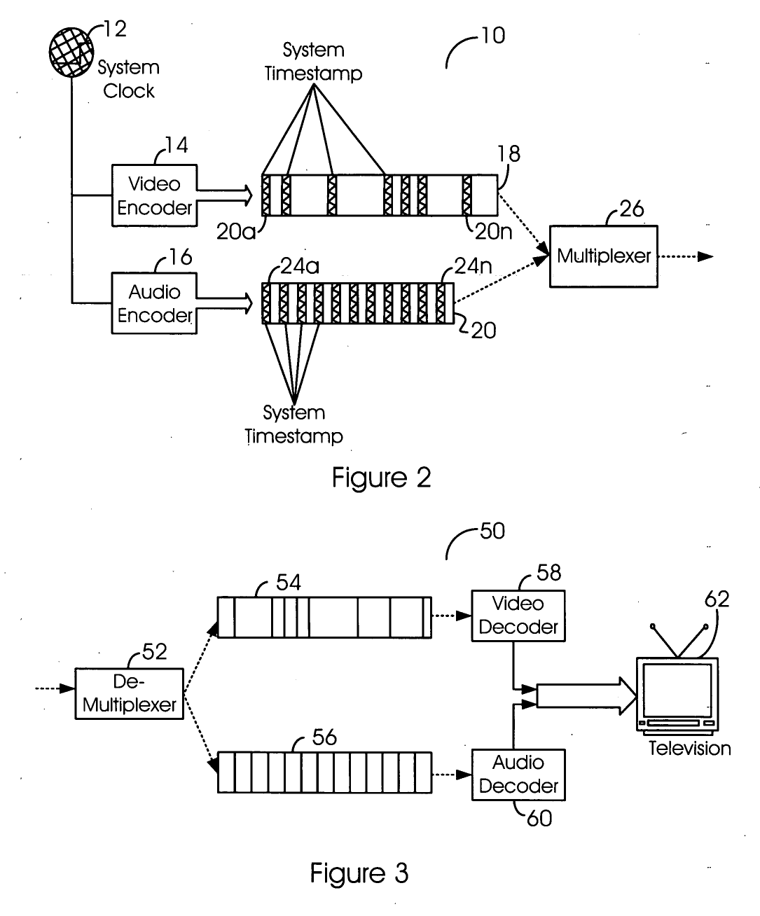

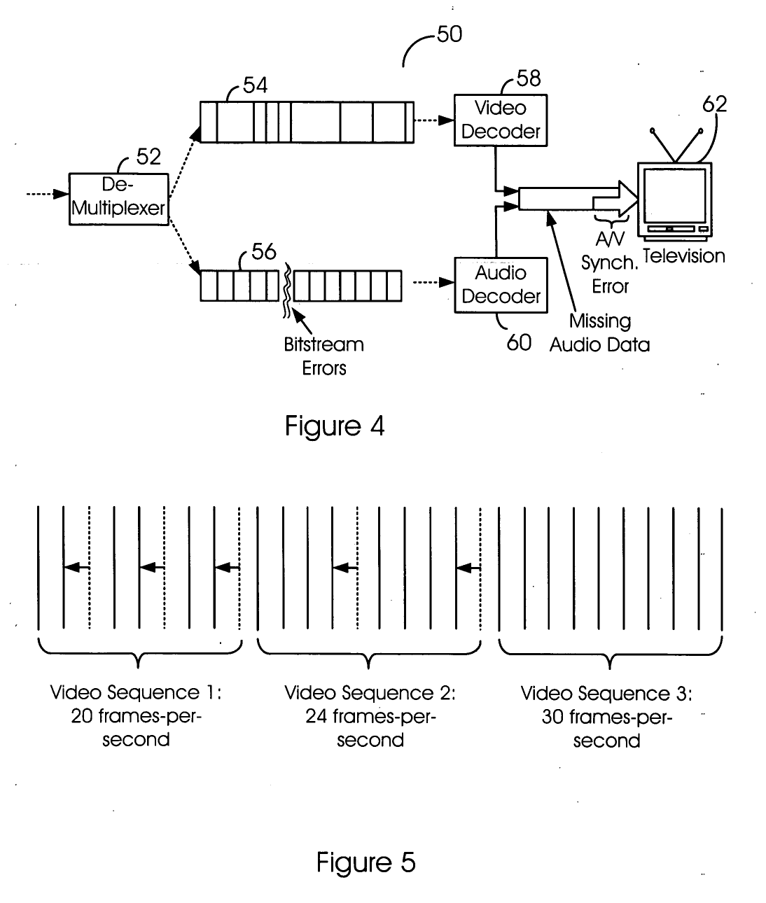

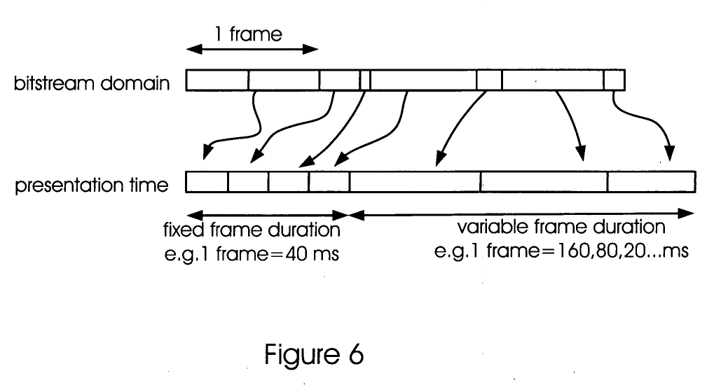

### DETAILED DESCRIPTION OF THE PREFERRED EMBODIMENTS

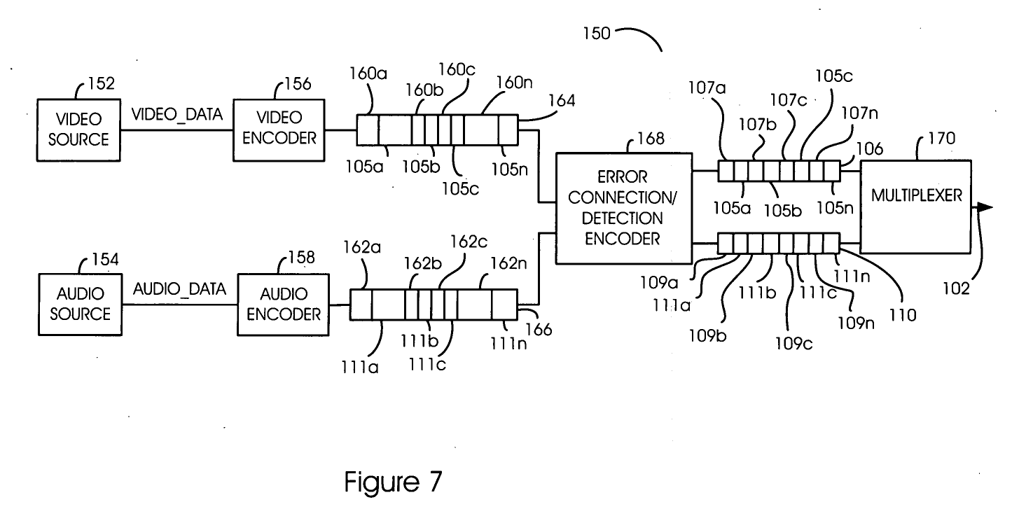

Referring to FIG. 7, a block diagram of a decoder system 100 is shown in accordance with a preferred embodiment of the present invention. The circuit 100 generally comprises a block (or circuit) 104, a block (or circuit) 108, a block (or circuit) 112, a block (or circuit) 114, and a block (or circuit) 116. The block 104 may be implemented as a de-multiplexer. The demultiplexer 104 may be implemented as an AVI de-multiplexer. The block 108 may be implemented as a video decoder. The block 112 may be implemented as an audio decoder 112. The block 114 may be implemented as an A/V synchronization circuit. The block 116 may be implemented as a display.

The AVI de-multiplexer 104 may receive a compressed video stream or a compressed audio stream on a signal 102. The AVI de-multiplexer 104 may present a compressed video stream 106 to the video decoder 108. The AVI de-multiplexer 104 may present a compressed audio stream 110 to the audio decoder 112. The compressed video stream 106 generally comprises a number of encoded video chunks 105a-105n in an AVI format and a number timestamp chunks 107a-107n. The compressed audio stream 110 may comprise a number of encoded audio chunks 111a-111n in an AVI format and a number of timestamp chunks 109a-109n. The video chunks 105a-105n and the audio chunks 111a-111n may be defined as A/V chunks. The A/V synchronization circuit 114 may present decompressed video and/or decompressed audio data to the display 116.

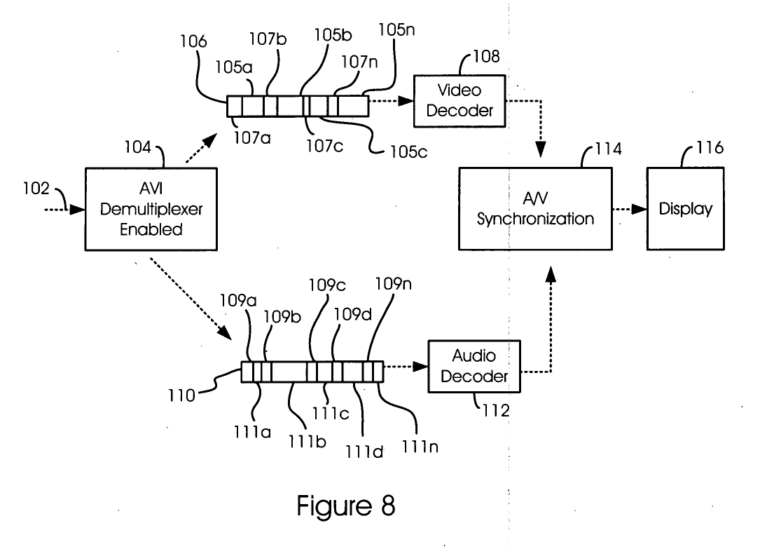

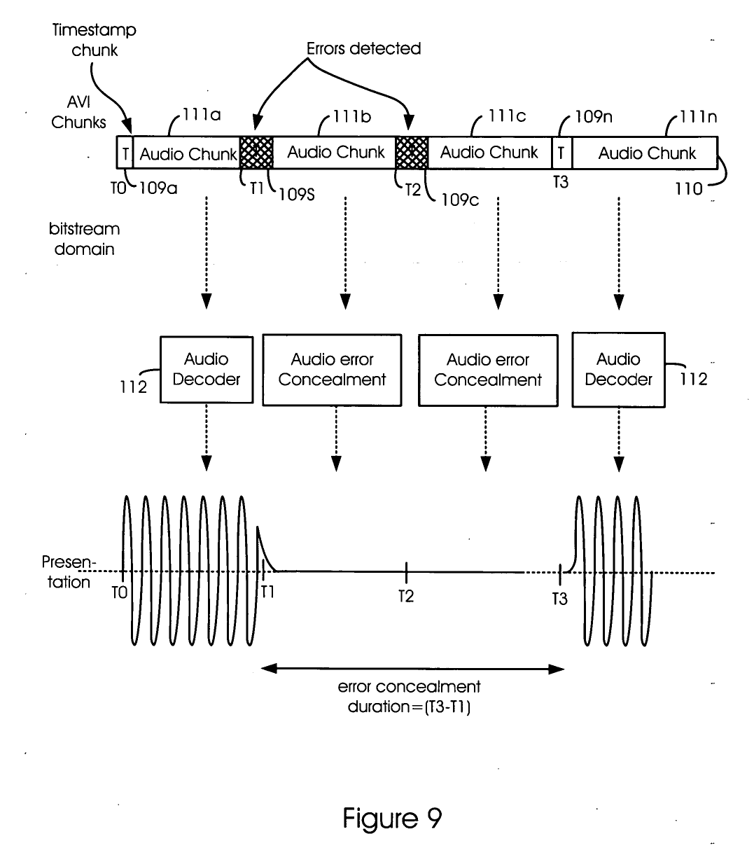

Each timestamp chunk may provide timing information for the following A/V chunk. For example, the timestamp chunk 107a may specify a time T. The following encoded video chunk 105a may be displayed at the time T specified by the timestamp chunk 107a. The order of the timestamp chunks 107a-107n in relation to the encoded video chunks creates a link with the encoded video chunks 105a-105n. The following chunks C(0), C(1), C(2), C(3), C(4) . . . C(N), may refer to the video chunks 105a-105n, the audio chunks 111a-111n, the timestamp chunks 107a-107n, and the timestamp chunks 109a-109n. If C(i) is a timestamp chunk, then the timestamp chunk C(i) provides all of the information (e.g., timestamp information, an error detection mechanism and an error correct mechanism) relevant to the audio or video chunk C(i+1). The error detection mechanism and the error detection mechanism will be discussed in more detail in connection with TABLE 1. The timestamp chunks 107a-107n and the timestamp chunks 111a-111n may be (i) fully compatible with the AVI chunk definition and (ii) safely ignored by systems currently not compatible of facilitating the present invention. The present invention may allow content creators to have the same file, which can be played back on legacy platforms and at the same time provide friendly systems with optimal multiplexing. The timestamp chunk may be inserted for each and every media chunk (e.g., video or audio). The insertion of the timestamp chunk into the compressed video stream 106 and the compressed audio stream 110 will be discussed in more detail in connection with FIG. 8. The present invention offers optimal results at frequent intervals to provide a decoder an opportunity to resynchronize video and audio data.

Each of the timestamp chunks 107a-107n and the timestamp chunks 111a-111n may include a timestamp chunk structure. The timestamp chunk structure is shown in the following TABLE 1:

TABLE 1
TIMESTAMP CHUNK STRUCTURE

typedef struct _timestampHeader {
FOURCC fcc;
DWORD cb;
DDWORD timestamp;
DWORD dwErrMode;
DWORD dwErrLength;
DWORD errData [N];
} TIMESTAMPHEADER;

The variable fcc is the “fourCC” (e.g., in the AVI terminology) describing the AVI chunk. The variable fcc comprises a two digit stream id and may be followed by a two character code “ts”. For example, for a stream ID 3, the fourCC may be set to “03ts”. The variable cb may be the total size in bytes of the timestamp header chunk. The variable timestamp may be the timestamp in microseconds for the next A/V chunk. The variable dwErrMode may be a fourCC describing the type of error detection used to protect the data stream integrity.

The timestamp chunks 107a-107n and the timestamp chunks 109a-109n may include a built in error detection mechanism (e.g., CRC and/or checksum for the next AVI chunk(s) positioned after the corresponding timestamp chunk). The error detection mechanism may detect an error in the compressed video stream 106 and/or the compressed audio stream 110. The error detection mechanism may apply a best error concealment in response to detecting an error on the compressed video stream 106 and/or the compressed audio stream 110. The best error concealment may include skipping an element (or any one of the particular encoded video chunks 105a-105n) and/or muting any one of the particular encoded audio chunks 111a-111n.

The error correction mechanism may be implemented in the timestamp chunk structure to correct possible errors and deliver an error resilient channel coding (e.g., Viterbi, Reed-Solomon, Turbo code techniques may be used to correct errors). The variable dwErrmode may implement a ‘crc’ (Cycle Redundancy Check) or ‘rs’ Reed Solomon to correct errors in the compressed video stream 106 and/or the compressed audio stream 110. The variable deErrLength may be the extra information length (e.g., stored in ‘errData’) needed for each and every error detection mode. For example, a CRC errData may include the CRC computed. For Reed Solomon, the errData may include redundancy bits. The error correction mechanism may (i) detect data corruption and (ii) allow the reconstructing of original data on the compressed video stream 106 and the compressed audio stream 110. The error correction mechanism may detect data corruption and reconstruct original data for the next chunk C(i+1). The next chunk C(i+1) may include audio, video and/or subtitles. The reconstruction of the original data on the compressed video stream 106 and the compressed audio stream 110 may include constraints based on how much error has been introduced onto the compressed video stream 106 and/or the compressed audio stream 110. A multiplexer may decide to have only some blocks protected (e.g., key frames of video) or all of the blocks protected. Implementing an independent timestamp for the AVI format may allow the use of the most advanced encoding tools available. The restrictions normally employed in the AVI format (used to maintain A/V synchronization) may no longer be necessary.

Referring to FIG. 8, an encoder system 150 is shown in accordance with the present invention. The encoder system 150 generally comprises a block (or circuit) 152, a block (or circuit) 154, a block (or circuit) 156, a block (or circuit) 158, a block (or circuit) 168, and a block 170. The block 152 may be implemented as a video course. The block 154 may be implemented as an audio source. The block 156 may be implemented as a video encoder. The block 158 may be implemented as an audio encoder. The block 168 may be implemented as an error correction/detection encoder. The block 170 may be implemented as a multiplexer. The video source 152 may present a signal (e.g., VIDEO_DATA) to the video encoder 156. The audio source 154 may present a signal (e.g., AUDIO_DATA) to the audio decoder.

The video encoder 156 may present an intermediate compressed video stream 164 to the error correction/detection encoder 168. The intermediate compressed video stream 164 generally comprises a number of timestamps 83a-83n and the number of video chunks 105a-105n. The audio encoder 158 may provide an intermediate compressed audio stream 166 to the error correction/detection encoder 168. The intermediate compressed audio stream 166 generally comprises a number of timestamps 85a-85n and the number of audio chunks 111a-111n. The error correction/detection encoder may generate and embed (i) the timestamp chunk 107a-107n into the compressed video stream 106 and (ii) the timestamp chunk 109a-109n into and the compressed audio stream 110. The error correction/detection encoder 170 may present the compressed video stream 106 to the multiplexer 170. The error correction/detection encoder 168 may present the compressed audio stream 110 to the multiplexer 170. The multiplexer 170 may present the compressed video stream 106 or the compressed audio stream on a signal 102.

The error correction/detection encoder 168 may encode the error detection and/or error correction information for the error correction mechanism by computing CRC and/or redundancy bits for Reed Solomon and/or Turbo. The error correction/detection encoder 168 may store the error correction information inside a timestamp chunk which precedes the audio chunk or the video chunk. The error detection mechanism and the error correction mechanism may be critical in protecting key elements in the compressed video stream 106 (e.g., in a video intra frame). The error correction mechanism may provide actual data which is capable of being decoded instead of data which is concealed due to the presence of corrupted data.

Since the present invention deals with A/V compression, quality and the compression ratio may be a concern. Adding extra information in the compressed bitstream 102 may add more bytes to the compressed bitstream 102. In particular, the error correction mechanism may add more bytes (e.g., redundancy bytes) to each timestamp chunk. To reduce the number of bytes added to the compressed bitstream 102, the present invention may implement (i) the error correction mechanism on key chunks (e.g., a first set of timestamp chunks) and/or (ii) the error detection mechanism to other chunks (e.g., a second set of timestamp chunks). The error detection mechanism may consume less bytes (i.e., less costly) than the error correction mechanism.

The present invention may provide the option of implementing only the error detection mechanism in the timestamp chunk to detect errors and to conceal errors during synchronization. The present invention may also provide the option of implementing only the error correction mechanism in the timestamp chunk to detect error and correct errors prior to decoding the compressed bitstream 102. The present invention may also provide the option of implementing both the error correction and error detection in the timestamp chunk. The particular implementation of either the error detection mechanism and/or the error correction mechanism may be varied to meet the design criteria of a particular implementation.

Referring to FIG. 8, a diagram illustrating the concealment of audio chunks based on the detection of errors is shown. For any of one of the particular encoded audio chunks 111a-111n positioned between any of one of the particular timestamp chunks 109-109n, the audio chunk 111a may be presented or concealed based on whether any of one of the particular timestamp chunks 109a-109n have detected any errors. For example, since the timestamp chunk 109a may not have an error detected in the next timestamp chunk 109a-109n, the audio chunk 111a may be passed through to the audio decoder 112. The decompressed audio from the audio decoder 112 may be presented to a user until a corresponding error is detected. Since an error may be detected on the next timestamp chunk 109b, the error detection mechanism may conceal (or mute) the audio data on the audio chunk 111b until the next timestamp chunk is free of errors. Since the timestamp chunk 109n may not have an error detected, the audio data on the audio chunk 111n may be decoded by the audio decoder 112 and presented to the user. The present invention may use the timestamp and the error detection mechanism to allow the decoder (e.g., an audio decoder or a video decoder) to (i) detect that audio or video data is missing (via corrupted data), (ii) know how much of the audio or video data is missing and (iii) provide an appropriate error concealment method to fill gaps in the audio or video stream caused by the corrupted data.

The compressed video stream 106 may be implemented similarly to the compressed audio stream 110. The compressed video stream 110 may have any one of the particular number of timestamp chunks 107a-107n positioned between any one of the particular video chunks 105a-105n. Any one of the particular video chunks 105a-105n may be presented or concealed based on whether any one of the particular timestamp chunks 107a-107n have any errors which are detected.

The present invention may (i) provide an error detection and correction mechanism built into the AVI format, (ii) provide an independent time stamping method regardless of the encoding tools for an AVI file, (iii) provide a backward compatible solution with existing deployed consumer electronics, (iv) enable the use of the most advanced encoding tools in the AVI format, (v) provide an AVI file format which is robust to transmission channel errors, (vi) allow an essentially perfect media synchronization, (vii) provide a 100% backwards compatibility with existing systems and/or (viii) provide a file that can be used on deployed and enabled systems where only the enabled system takes full advantage of the present invention.

While the invention has been particularly shown and described with reference to the preferred embodiments thereof, it will be understood by those skilled in the art that various changes in form and details may be made without departing from the spirit and scope of the invention.

1. An apparatus comprising:
a first circuit configured to embed one or more timestamp chunks into a compressed bitstream in response to one of a video data signal and an audio data signal; and
a second circuit configured to generate an output signal in response to decoding said compressed bitstream, wherein each of said one or more timestamp chunks comprises an error correction mechanism configured to detect and correct errors on said compressed bitstream prior to decoding said compressed bitstream.

2. The apparatus according to claim 1, wherein said each of one or more timestamp chunks further comprises:
an error detection mechanism configured to detect and conceal errors on said compressed bitstream.

3. The apparatus according to claim 2, wherein said each of one or more timestamp chunks further comprises a timestamp.

4. The apparatus according to claim 3, wherein said first circuit further comprises:
a video encoder configured to generate an intermediate video bitstream in response to encoding said video data signal; and
an audio encoder configured to generate an intermediate audio bitstream in response to encoding said audio data signal.

5. The apparatus according to claim 4, wherein said intermediate video bitstream further comprises one or more video chunks in an audio-video interleaved format.

6. The apparatus according to claim 5, wherein said intermediate audio bitstream further comprises one or more audio chunks in said audio-video interleaved format.

7. The apparatus according to claim 6, wherein said first circuit further comprises:
an error correction/detection encoder configured to (i) generate said timestamp chunks and (ii) produce a compressed video bitstream and a compressed audio bitstream.

8. The apparatus according to claim 7, wherein said compressed video bitstream comprises said timestamp chunk positioned before said video chunk, wherein said timestamp chunk provides (i) timestamp information (ii) said error correction mechanism and (iii) said error detection mechanism for said video chunk positioned after said timestamp chunk.

9. The apparatus according to claim 8, wherein said compressed audio bitstream comprises said timestamp chunk positioned before said audio chunk, wherein said timestamp chunk provides (i) timestamp information (ii) said error correction mechanism and (iii) said error detection mechanism for said audio chunk positioned after said timestamp chunk.

10. The apparatus according to claim 7, wherein said first circuit further comprises:
a multiplexer coupled to said error correction detection encoder and configured to generate said compressed bitstream.

11. The apparatus according to claim 1, wherein said error correction mechanism is configured to correct errors on said compressed bitstream with one of a cyclic redundancy check, Reed Solomon coding and Turbo coding.

12. The apparatus according to claim 2, wherein said timestamp chunks includes a first set of timestamp chunks and a second set of timestamp chunks.

13. The apparatus according to claim 12, wherein each of said first set of timestamp chunks includes a timestamp and said error correction mechanism.

14. The apparatus according to claim 12, wherein each of said second set of timestamp chunks includes a timestamp and said error detection mechanism.

15. An apparatus comprising:
means for embedding one or more timestamp chunks into a compressed bitstream in response to one of a video data signal and an audio data signal; and
means for generating an output signal in response to decoding said compressed bitstream, wherein each of said one or more timestamp chunks comprises an error correction mechanism configured to detect and correct errors on said compressed bitstream prior to decoding said compressed bitstream.

16. A method for inserting timestamps into an audio-video interleaved file, comprising the steps of:
(A) embedding one or more timestamp chunks into a compressed bitstream in response to one of a video data signal and an audio data signal; and
(B) generating an output signal in response to decoding said compressed bitstream, wherein each of said one or more timestamp chunks comprises an error correction mechanism configured to detect and correct errors on said compressed bitstream prior to decoding said compressed bitstream.

17. The method according to claim 16, wherein step (B) further comprises the step of:
detecting and concealing errors on said compressed bitstream with an error detection mechanism within said timestamp chunk.

18. The method according to claim 17, further comprising the step of:
generating said timestamp chunks with an error correction/detection encoder.

19. The method according to claim 18, further comprising the step of:
positioning each of said timestamp chunks before a video chunk on a compressed video bitstream; and
positioning each of said timestamp chunks before an audio chunk on a compressed audio bitstream.

20. The method according to claim 16, further comprising the step of:
correcting said errors on said bitstream with one of a cyclic redundancy check, Reed-Solomon coding, or Turbo coding.
